(19) United States
(12) Patent Application Publication
(10) Pub. No.: US 2007/0155441 A1
(43) Pub. Date: Jul. 5, 2007

(54) Network control system adapted to provide services to mobile devices regarding mobile device battery life

(75) Inventor: Joseph A. Carbonaro, Wheaton, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/322,945

(22) Filed: Dec. 30, 2005

(51) Int. Cl. H04B 1/38

(52) U.S. Cl. 455/571

(57) ABSTRACT

A network control system adapted to receive battery characteristics from a mobile device. The battery characteristics are transmitted to the network control system upon the entry of an on-demand feature code into the mobile device. The network control system processes the received battery characteristics, as well as received information specifying the magnitude of the RF signal power of the mobile device. The processed information is used to generate information representing the estimated service life of the present charge of the battery of the mobile device. The generated information is transmitted by the network control system to the mobile device for display. The mobile device may transmit information to the network control system regarding the battery characteristics as well as the size of a file to be downloaded. The network control system transmits generated information to the mobile device indicating the estimated service life of the present battery charge as well as the estimated time to download the file. The displays may be in the time domain, or in a visual or multimedia format, or may be announcements.

### RELATED APPLICATION

This application is related to a co-pending application by the same inventor having U.S. Ser. No. 11/168,134, filed Jun. 27, 2005.

### FIELD OF THE INVENTION

This invention relates to a method and apparatus for operating a network control system adapted to provide services for mobile devices. This invention further relates to a network control system adapted to receive information from mobile devices, to process the received information, and to transmit the information to the mobile devices regarding the batteries of the mobile devices. This invention further relates to a network control system that is adapted to provide information to mobile devices regarding the estimated service life of the present charge of the batteries.

### Problem

Mobile devices, such as mobile phones, cell phones, PDAs, etc, are powered by portable energy sources such as batteries. Mobile devices function satisfactorily as long as their batteries have an adequate charge. Mobile devices employ bar indicators to indicate the magnitude of the present battery charge. Bar indicators are adequate for some, but not all, users. Bar indicators may be adequate for users who do not require an accurate indication of the present battery charge. An example of such users may be those who only occasionally view a bar indicator to determine when it is time to charge the battery.

Bar indicators do not fulfill the needs of many mobile device users who require an accurate display of battery charge information. These users require a battery charge indicator that displays information having sufficient accuracy to enable them to determine whether the present charge is sufficient to operate the mobile device for use on a long-duration call or for the downloading of a large file.

An indicator having a single bar may represent one quarter, one third, or one half of the present battery charge. This information is of little value to a user who may not remember the power rating or installation date of the battery. The information displayed by a bar indicator is at best an approximation and does not have the accuracy required by a demanding user.

In summary, the currently available bar indicators are inadequate since they do not provide battery charge information having the accuracy required by many users.

### Solution

The present invention solves the above and other problems by the provision of a network control system adapted to provide accurate battery charge information to mobile devices. The provided information has the accuracy required to enable mobile device users to determine the adequacy of the present battery charge for use on long-duration calls and the downloading of large files.

In operation, the network control system is adapted to receive battery characteristics information from the mobile device as well as information regarding the RF signal power generated by the mobile device. Network control system processes the received battery characteristics and RF signal power information to generate accurate information regarding the magnitude of the present battery charge. Network system control also calculates the RF signal power level the mobile device requires to transmit and receive messages to/from a base station. The network control system then transmits information to the mobile device regarding the magnitude of the estimated service life of the present battery charge The generated battery charge information is displayed by the mobile device in the time domain and with an accuracy that is superior to that provided by bar type indicators. The displayed information has improved accuracy since it is based upon the battery characteristics as well as the RF signal power of the mobile device. Existing mobile devices may display the battery charge information provided by the present invention without requiring extensive modifications.

The battery characteristics received by the network control system may include the battery voltage as well as other information such as the rated battery power specified by the battery manufacturer, the rated battery life, the date of installation in the mobile device, the battery temperature, the estimated service life of the present battery charge, etc. These battery characteristics are received by the network control system and processed to generate an indication of the magnitude of the estimated service life of the present battery charge. This generated information is transmitted to the mobile device for use by the user in determining the adequacy of the magnitude of the present battery charge. The received battery charge information may be displayed in various forms. In accordance with a first embodiment, the estimated service life of the present battery charge information may be displayed in a time domain (hours, minutes) on the screen of the mobile device. The network control system is adapted to receive information regarding the location of the mobile device as well as the magnitude of the RF signal power of the mobile device. The network control system receives RF signal power information and the battery characteristics to generate information of increased accuracy.

The network control system may also transmits a message to a first intelligent peripheral instructing it to transmit the generated estimated service life of the present battery charge information to the mobile device as an announcement, a tone, or as a visual or multimedia display. The battery charge information generated by the network control system may be transmitted to a second intelligent peripheral that and converts the generated information to text messages. The text messages are transmitted in a suitable format to mobile device 120. The displayed messages may advantageously use the Short Message Service (SMS) feature.

The network control system is also adapted to assist mobile device users in determining whether the estimated service life of the present battery charge is adequate for downloading large files or for use on a long-duration call. The network control system assists mobile device users by receiving the battery characteristics and the size of a file to be downloaded from the mobile device. The network control system processes the received information, determines the time required for the downloading, and generates information indicating whether the estimated service life of the present battery charge is sufficient to power the mobile device for the time required for the downloading. This generated information is then transmitted by the network control system to the mobile device for display.

The displayed information may take various forms. In a first embodiment, the estimated service life of the battery charge and the time required to download the file is displayed in the time domain. In another embodiment, the generated information may be transmitted by the network control system to the first intelligent peripheral. The first intelligent peripheral receives the generated information and transmits the generated information to the mobile device as an audible announcement, a tone, or as a multimedia or visual indication specifying whether the present battery charge is sufficient for the user's needs. Alternatively, the generated information may be received from network control system by a second intelligent peripheral for transmission to the mobile device as a text message stating “yes—please proceed” or a “no” warning the user that the present battery charge is inadequate. The same battery charge information as above discussed for the downloading of files may be provided to the mobile device for use on a long-duration conference call.

The above battery characteristics may advantageously be received by the network control system by the dialing of an on-demand feature code, such as *xx, into the mobile device. The feature code may be dialed during either the idle or talk state of the mobile device. The dialing of the feature code is detected by the processor of the mobile device which initiates the procedures required to enable the mobile device to transmit the above discussed battery characteristics to the network control system.

It may be seen from the above that the battery charge information provided to the mobile device user in accordance with the present invention overcomes the above problems of bar type indicators.

### DESCRIPTION OF THE DRAWINGS

The above and other advantages and features of the invention may be better understood from a reading of the following detailed description thereof taken in conjunction with the drawings in which:

FIG. 1 discloses one possible embodiment of the invention;

FIG. 2 is a flow chart illustrating the method steps executed by the network control system 102 of FIG. 1;

FIG. 3 illustrates a possible display for the idle state of mobile device 120;

FIG. 4 illustrates a possible display for the talk state of mobile device 120;

FIG. 5 illustrates displays of mobile device 120 during the downloading of a file; and

FIG. 6 is a flowchart illustrating the method steps executed by the apparatus of the present invention.

### DETAILED DESCRIPTION

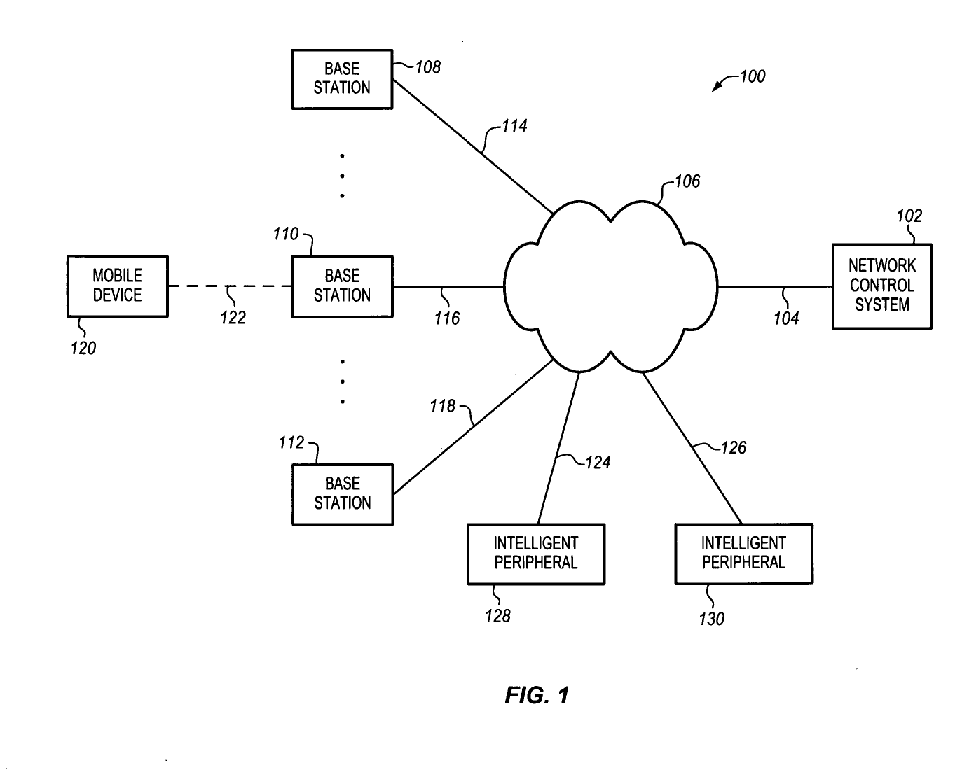

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

Description of FIG. 1

FIG. 1 discloses wireless network 100 having a network control system 102, network 106, mobile device 120, and base stations 108, 110, and 112. FIG. 1 further discloses a first intelligent peripheral 128 and a second intelligent peripheral 130.

In operation, mobile device 120 transmits information to network control system 102 regarding the characteristics of the battery installed in mobile device 120. The battery characteristics are transmitted from mobile device 120 to network control system 102 via path 122, base station 110, path 116, network 106, and path 104. The received battery characteristics may include the battery voltage as well as other information such as the rated battery power specified by the battery manufacturer, the rated battery life, the date of installation in the mobile device, the battery temperature, the estimated service life of the present battery charge, etc. Network control system 102 also receives information regarding the RF signal power generated by mobile device 120. Network calculates the RF signal power mobile device 120 requires to transmit and receive messages to/from a base station. Network control system 102 processes the received battery characteristics and RF signal power information and generates information regarding the estimated service life of the present battery charge. This generated information is transmitted to mobile device 120 via the above-described path. The estimated service life of the present battery charge is displayed by mobile device 120 in a time domain with an accuracy and user convenience that is superior to that provided by the bar indicator of mobile device 120. The estimated service life of the present battery charge is displayed without requiring extensive modifications to mobile device 120. The estimated service life of the displayed battery charge may indicate the estimated service life of the present battery charge for the idle state or for the talk state of mobile device 120. Mobile device 120 may also be operated to alternate the display between the idle and talk states, one state at a time.

A display of the estimated service life of the present battery charge may be provided to mobile device 120 on an on-demand basis wherein the user operates the keys of mobile device 120 to enter a feature code (*xx) into mobile device 120. Network control system 102 responds by transmitting the dialed feature code via the priorly described path to network control system 102. Network control system 102 responds by transmitting a signal to mobile device 120 instructing it to transmit the battery characteristics to network control system 102 over the above-described path.

Mobile device 120 may be operated to display the estimated service life of the present battery charge for a brief or for an extended period of time as desired by the user of mobile device 120. The battery charge information displayed by mobile device 120 may be of various forms. In accordance with one embodiment, the displayed estimated service life of the battery charge information received by mobile device 120 may be displayed in a time domain (hours, minutes). Other possible displays are subsequently described.

In accordance with one embodiment, network control system 102 transmits the generated information to the a first intelligent peripheral 128 together with instructions that enable the first intelligent peripheral 128 to transmit the generated information to mobile device 120 as a visual display, or as a multimedia display or as audio information, or a tone, in accordance with the needs of the user of mobile device 120. In accordance with another embodiment, network control system 102 transmits the generated information to a second intelligent peripheral 130 via network 106 and path 126. Intelligent peripheral 130 converts the generated information to a suitable message, using the Short Message Service (SMS) feature, which is transmitted to mobile device 120 for display in a format desired by the user.

Network control system 102 can also assist the users of mobile device 120 in the downloading of large files while avoiding the possibility of a battery failure during the downloading. In accordance with this embodiment, mobile device 120 transmits the above discussed battery characteristics and the size of the file to be downloaded to network control system 102. Network control system 102 determines whether the present battery charge is adequate to power mobile device 120 for the time required to download the file, and transmits generated information to the user of mobile device 120 indicating whether or not the present battery charge is an adequate.

The information displayed by mobile device 120 may take various forms. In one embodiment, the necessary information, including the estimated service life of the present battery charge and of the time required to download the file may be displayed in the time domain to the user for a determination as to whether to proceed with the download.

The capability of the service life of the battery charge for the purposes envisioned by the user may be transmitted to intelligent peripheral 128 for the generation of an audible, visual, or multi-media indication signifying whether the estimated service life of the present battery charge is sufficient to meet the needs of the user. This information is transmitted by the first intelligent peripheral 128 to mobile device 120 for display. Alternatively, the adequacy of the estimated service life of the present battery charge may be presented to the mobile device 120 by means of a text message generated by the second intelligent peripheral 130. This text message may take various forms such as a message stating “Yes. Please Proceed” or a “No” warning that the present charge is not adequate. The same generated information as above discussed for the downloading of the files may be transmitted by network control system 102 to mobile device 120 to provide a display regarding the adequacy of the estimated service life of the present battery charge for use on long-duration calls and the like.

It may be seen from the above that the information provided by network control system 102 to mobile device 120 provides superior and more user-friendly information to the user than that provided by a bar type indicator.

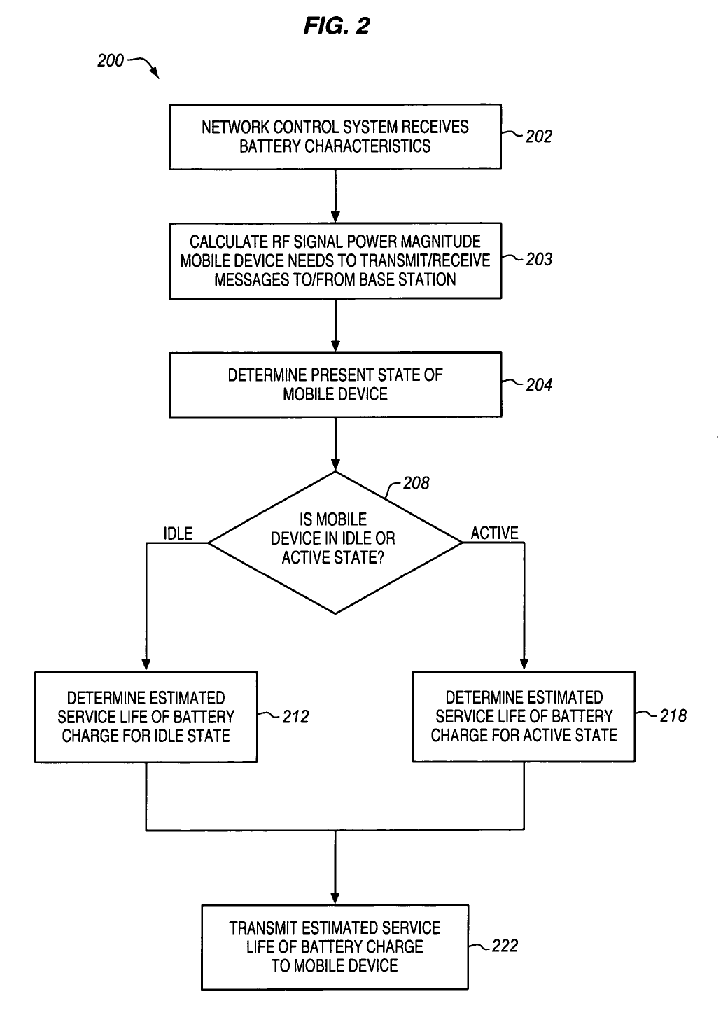

Description of FIG. 2

FIG. 2 is a flowchart 200 illustrating the steps employed by network control system 102 in the performance of its call serving functions. These steps provide for a determination and display of the estimated service life of the present charge of the battery of mobile device 120. The steps of FIG. 2 illustrate the operation of network control system 102 and mobile device 120 for the idle state or for the active state of mobile device 120.

In step 202, the network control system 102 receives the battery characteristics from mobile device 120. In step 203, network control system 102 calculates the RF signal power that mobile device 120 requires to transmit/receive messages to/from a base station 110, such as base station 110. In step 204, the network control system 102 determines the present operational state of mobile device 120.

In step 208, network control system 102 determines whether the mobile device 120 is in an idle or active state. If step 208 specifies an idle state, step 212 determines the estimated service life of the battery charge for the idle state of mobile device 120. This determination is made using the received battery characteristics as well as information regarding the RF signal power of mobile device 120. If step 208 specifies an active state, step 218 determines the estimated service life of the present battery charge for the active state of mobile device 120. This determination is made using the received battery characteristics as well as information regarding the RF signal power of mobile device 120. In step 222, network control system transmits the determined estimated service life of the battery charge for the determined state to mobile device 120 for display. Mobile device 120 may also be operated in a blinking state to alternately display estimated service life of the present battery charge for each state sequentially, one state at a time.

The estimated service life of the present battery charge for the active state may be determined by network control system 102 by multiplying the estimated service life of a present battery charge for the idle state by a percentage factor. The estimated service life of a present battery charge for the active state may be determined by sampling the consumed power for the mobile communication device during its active state. Alternatively, the estimated service life of a charge for the active state may be determined by using the RF signal power of mobile device 120.

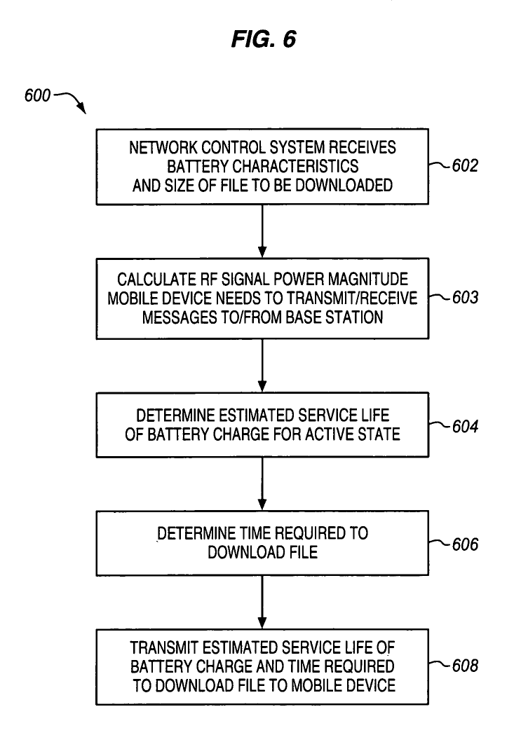

The steps of FIG. 2 may generate information indicating whether the estimated service life of the present battery charge is sufficient to permit the downloading of a data file in the active state. As shown in FIG. 6, this is done by the steps of receiving information indicating the size of a file to be downloaded, by determining the estimated service life of the present charge of the battery for the active state, and by generating information indicating whether the estimated service life of the present battery charge is sufficient to operate the mobile device 120 for the time required to download the data file. The determined information is transmitted to mobile device 120.

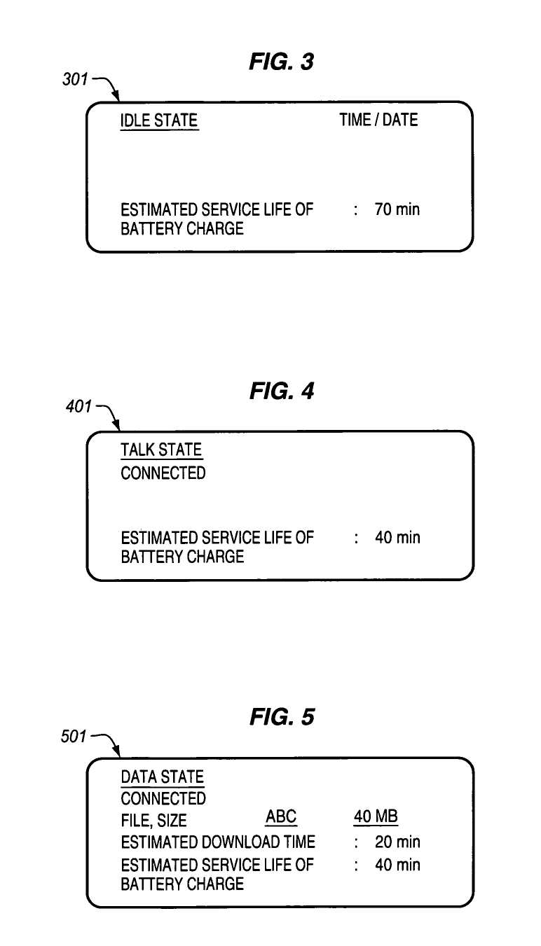

Description of FIG. 3

FIG. 3 illustrates a display screen 301 of mobile device 120 for the idle state. The left portion of the top line of the display specifies the idle state; the right portion of the line specifies time/date information. The bottom line of the display indicates that the estimated service life of the present charge of the battery for the idle state is 70 minutes.

Description of FIG. 4

FIG. 4 illustrates a display screen 401 representing the talk state of mobile device 120. The top line of the display indicates the talk state. The next line indicates that mobile device 120 is in a connected state. The third line indicates that the estimated service life of the present charge of the battery is 40 minutes.

Description of FIG. 5

FIG. 5 shows a display 501 representing the data state of mobile device 120. The top line specifies that mobile device 120 is in a data state. The second line indicates that mobile device 100 is in a connected state. The third line indicates the file name and size. The next line indicates an estimated download time of 20 minutes. The bottom line indicates the estimated service life of the present battery charge is 40 minutes.

Description of FIG. 6

FIG. 6 is a flow chart 600 illustrating the steps executed by a network control system 102 for the generation of information regarding the downloading of a file.

In step 602, the network control system 102 receives the battery characteristics and the size of the file to be downloaded from mobile device 120. In step 603, network control system 102 calculates the RF signal power mobile device 120 requires to transmit/receive messages to/from a base station, such as base station 110. In step 604, network control system 102 uses the received battery characteristics and the RF signal power information to determine the estimated service life of the present battery charge for the active state of mobile device 120. In step 606, network control system 102 determines the time required by mobile device 120 to download the file. In step 608, network control system 102 transmits to mobile device 120 the estimated service life of the present battery charge and the estimated time required to download the data file.

I claim:

1. A method of operating a wireless network comprising a network control system, said method comprising the steps of:
operating said network control system to receive the characteristics of a battery of a mobile device;
operating said network control system to receive information representing the magnitude of the RF signal power of said mobile device;
operating said network control system to generate information regarding the estimated service life of the present charge of said battery based using said received battery characteristics and said information regarding said magnitude of said RF signal power; and
operating said network control system to transmit said estimated service life of the present charge of said battery to said mobile device for display in the time domain.

2. The method of claim 1 wherein said battery characteristics and said information regarding the magnitude of said RF signal power are transmitted to said network control system in response to the dialing of an on-demand feature code by a user of said mobile device.

3. The method of claim 1 wherein said display may controllably represent the estimated service life of the present charge of said battery for an idle state, or for a talk state of said mobile device, or for both said idle and talk states sequentially, one state at a time.

4. The method of claim 1 including the further steps of:
operating said network control system to receive said battery characteristics and said information representing the magnitude of said currently RF signal power of said mobile device, and to further receive information representing the size of a file that a user of said mobile device desires to download;
operating said network control system to determine the estimated time required to download said file as well as the estimated service life of the talk state of said battery of said mobile device;
operating said network control system to generate information indicating whether the estimated service life of the present charge of said battery is sufficient to download said file; and
transmitting said generated information to said mobile device for display in said time domain.

5. The method of claim 1 further including a first intelligent peripheral which receives said generated information and transmits said generated information to said mobile device as an audible announcement or tone, or as a display in a visual or multimedia format.

6. The method of claim 1 further including a second intelligent peripheral which receives said generated information and transmits said generated information as a text message to said mobile device for display in said time domain.

7. The method of claim 2 wherein said on-demand feature code may be received by said network control system from a said mobile device during the idle state or talk state of said mobile device.

8. Apparatus defining a network control system adapted to provide information to a mobile device regarding the estimated service life of the present charge of a battery of said mobile device, said network control system comprising:
apparatus adapted to receive information regarding the characteristics of a battery of said mobile device;
apparatus adapted to receive information representing the magnitude of the RF signal power of said mobile device;
apparatus responsive to derive the estimated service life of the present charge of said battery based upon the receipt of said battery characteristics as well as said information representing the magnitude of said RF signal power, and
apparatus adapted to transmit said estimated service life of the present charge of said battery to said mobile device for display in the time domain.

9. The network control system of claim 8 wherein said battery characteristics and said information regarding the magnitude of said RF signal power are transmitted to said network control system in response to the dialing of an on-demand feature code by a user of said mobile device.

10. The network control system of claim 8 wherein said display may controllably represent the estimated service life of the present charge of said battery an the idle state or for a talk state of said mobile device, or for said idle and talk states sequentially, one state at a time.

11. The network control system of claim 8 further including:
apparatus adapted to receive said battery characteristics, and said information representing said magnitude of said RF signal power, and further adapted to receive information representing the size of a file that a user of said mobile device desires to download;
apparatus adapted to determine the estimated time required to download said file as well as the estimated service life of the talk state of said battery of said mobile device;
apparatus adapted to generate information indicating whether the estimated service life of the present charge of said battery is sufficient to download said file; and
apparatus adapted to transmit said generated information to said mobile device for display in a time domain.

12. The network control system of claim 8 in combination with a first intelligent peripheral which receives said generated information and transmits of said generated information to said mobile device as an audible announcement or tone, or as a display having a visual or multimedia format.

13. The network control system of claim 8 in combination with a second intelligent peripheral which receives said generated information and transmits said generated information as a text message to said mobile device for display in a time domain.

14. The network control system of claim 9 further comprising apparatus adapted to receive said feature code during an idle or a talk state of said mobile device.

15. Apparatus defining a network control system adapted to provide information to a mobile device regarding the estimated service life of the present charge of a battery of said mobile device, said network control system comprising:
apparatus adapted to receive information regarding the characteristics of a battery of said mobile device;
apparatus that is operable in response to the receipt of said battery characteristics to generated information regarding the estimated service life of the present charge of said battery; and
apparatus adapted to transmit said estimated service life of the present charge of said battery to said mobile device for display in the time domain.

16. The network control system of claim 15 wherein said battery characteristics are transmitted to said network control system in response to the dialing of an on-demand feature code by a user of said mobile device.

17. The network control system of claim 15 wherein said display may controllably represent the estimated service life of the present charge of said battery for an idle state of said mobile device, or for a talk state of said mobile device, or for said idle and talk states of said device sequentially, one state at a time.

18. The network control system of claim 15 further including:
apparatus adapted to receive said battery characteristics and further adapted to receive information representing the size of a file that a user of said mobile device desires to download;
apparatus adapted to determine the estimated time required to download said file as well as the estimated service life of the talk state of said battery of said mobile device;
apparatus adapted to generate information indicating whether the estimated service life of the present charge of said battery is sufficient to download said file; and
apparatus adapted to transmit said generated information to said mobile device for display in a time domain.

19. The network control system of claim 15 in combination with:
a first intelligent peripheral that receives said generated information from said network control system and transmits said generated information to said mobile device as a tone or an audible announcement, or as a display having a visual or multimedia format; and
a second intelligent peripheral that receives said generated information and transmits said generated information as a text message to said mobile device as a display in a time domain.

20. The network control system of claim 15 further comprising apparatus adapted to receive on-demand feature code during an idle or a talk state of said mobile device.
